(19) United States
(12) Patent Application Publication
(10) Pub. No.: US 2005/0204019 A1
(43) Pub. Date: Sep. 15, 2005

(54) Content distribution using CD/DVD burners, high speed interconnects, and a burn and return policy

(76) Inventors: James P. Flynn, Northampton, MA (US); William D. Clarke, Florence, MA (US)

Correspondence Address: OLYMPIC PATENT WORKS PLLC, P.O. BOX 4277, SEATTLE, WA, 98104, US

(21) Appl. No.: 11/058,730

(22) Filed: Feb. 14, 2005

Related U.S. Application Data
(60) Provisional application No. 60/544,597, filed on Feb. 13, 2004.

(51) Int. Cl. H04L 12/54

(52) U.S. Cl. 709/219; 713/150

(57) ABSTRACT

Embodiments of the present invention provide services that enable individuals to rent and/or purchase content over the Internet and to receive it electronically, referred to below as “EZTakes.” This content may include movies, TV shows, music, games and other information typically distributed on CD/DVD. EZTakes leverages high-speed broadband Internet connections, peer-to-peer networking, digital rights management (DRM) and the growing prevalence of home computers that now typically feature large hard drives (e.g. 180+gigabytes) and have the capability to “burn” (i.e. create) DVDs and/or CDs. EZTakes bridges the gap between the home computer and the living room by using standard technologies that consumers already own and are already familiar with: home computers, DVD media, DVD players and the Internet. EZTakes also promotes the interests of content owners (e.g. movie production companies) by expanding their revenue opportunities through enabling them to distribute their content assets over the Internet. EZTakes also includes technical control mechanisms, such as digital watermarking, that could not easily be exploited when using physical DVD/CD distribution channels.

### CROSS REFERENCE

This application claims the benefit of provisional Patent Application No. 60/544,597, filed Feb. 13, 2004.

### TECHNICAL FIELD

The present invention is related to information distribution and, in particular, to distribution of music, video, computer software, games, and other information for rent and/or purchase over the Internet while protecting the interests of content providers.

### BACKGROUND OF THE INVENTION

Content delivered over the Internet is typically downloaded to a computer. The consumer behavior observed so far strongly suggests that people consistently prefer to enjoy content on their home TV, which is usually in a different room from their home computers. At the same time, these consumers either do not wish to connect their home computers to their TVs, or find that the technology needed to do so is much too complex, making the work not worth the effort.

The quality of the content distributed over the Internet is invariably reduced in order to create a smaller file size, which can be downloaded faster. This is especially important when servicing customers over lower speed dial-up connections. Moreover, services typically employ special CODEC (coder/decoder) software to compress content in order to further improve download performance. An unfortunate side effect of converting the file format is that the resultant downloaded content can only be played back on a computer by using software that offers a compatible CODEC. The problem with the downloaded content file is that it is in a special compressed format that is not compatible with standard home entertainment equipment, such as a DVD player.

Because of practical bandwidth limitations, high-quality content, such as DVDs (which could be several gigabytes in size) are too large to download on demand via a typical client-to-server configuration. This bottleneck not only bogs down client connections, but also may overwhelm a content server even more quickly as the number of client requests grows. While technical solutions exist to mitigate the server bottleneck, such as server farms and products from companies like Akami, the costs of providing the appropriate physical infrastructure for a large-scale service of this nature is prohibitive. Moreover, even with a large infrastructure investment, service levels would still likely be unreliable.

FIG. 1 illustrates the problem of traditional server-to-client content download configurations. In FIG. 1, a number of clients (i.e. C1 through CN) are in the process of downloading content from a content server running a hosted service for distributing content over the Internet. As indicated in FIG. 1, the optimal bandwidth for a content server is a function of the number of clients (i.e. the “N” in CN) and the needed bandwidth to fully exploit all of the clients' Internet connections. Even assuming a very efficient scenario, it would take several hours to download one typical DVD movie file to a client with a 256 kbps broadband connection. In actuality, network overhead and latency is likely to make download times much longer since the available client bandwidth is not likely to be fully exploited. Artio tests indicate that it could take as much as 20 hours to download one DVD movie by using a one-to-one configuration. Consequently, server-to-client connections of this type need to stay open for quite a long time in order to complete a download.

An inherent problem with a traditional server-to-client content distribution configuration is that infrastructure costs increase in direct proportion to the number of client requests. When one considers that a large commercial content distribution service might need to service hundreds or even thousands of simultaneous clients that may be connected for up to 20 hours for each transaction, it starts to become clear that the traditional server-to-client download configuration is prohibitively expensive for high-quality content distribution.

Content owners are extremely wary of distributing their assets electronically, let alone over the public Internet. Plummeting sales for music labels due to content piracy via file sharing networks like Kazza have increased these fears and have also served as a warning to video content owners that they need to take steps to avoid the “Napsterization” of their business model. Some of these companies may resort to a litigation-only approach in an attempt to protect distribution models that are becoming obviated by new technologies. Forward-looking content owners, however, will also consider how to adapt their businesses and eventually even learn how to exploit technologies to create new opportunities.

### SUMMARY OF THE INVENTION

Embodiments of the present invention provide services that enable individuals to rent and/or purchase content over the Internet and to receive it electronically, referred to below as “EZTakes.” This content may include movies, TV shows, music, games and other information typically distributed on CD/DVD. EZTakes leverages high-speed broadband Internet connections, peer-to-peer networking, digital rights management (DRM) and the growing prevalence of home computers that now typically feature large hard drives (e.g. 180+gigabytes) and have the capability to “burn” (i.e. create) DVDs and/or CDs. EZTakes bridges the gap between the home computer and the living room by using standard technologies that consumers already own and are already familiar with: home computers, DVD media, DVD players and the Internet. EZTakes also promotes the interests of content owners (e.g. movie production companies) by expanding their revenue opportunities through enabling them to distribute their content assets over the Internet. EZTakes also includes technical control mechanisms, such as digital watermarking, that could not easily be exploited when using physical DVD/CD distribution channels.

### BRIEF DESCRIPTION OF THE DRAWINGS

FIG. 1 illustrates the problem of traditional server-to-client content download configurations.

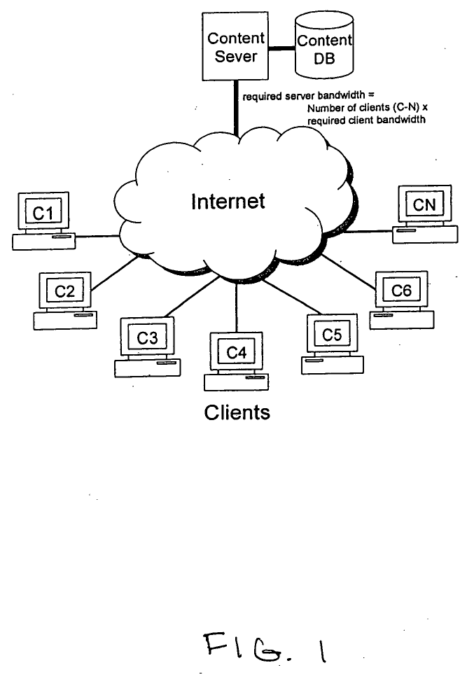

FIG. 2 illustrates how the EZTakes network functions.

FIG. 3 illustrates an exemplary user interface.

FIG. 4 shows an options window.

FIG. 5 shows text that could, for example, be shown in an initial splash screen.

FIG. 6 illustrates the Setup process.

FIG. 7 illustrates the test burn and return process.

FIG. 8 illustrates the registration process.

FIG. 9 illustrates the Preference Maintenance process.

FIG. 10 illustrates the personal inventory maintenance process.

FIG. 11 illustrates the identify content to replace process.

FIG. 12 illustrates the identify new content for download process.

FIG. 13 illustrates the normal operation process.

FIG. 14 illustrates the select content process.

FIG. 15 illustrates the burn content process.

FIG. 16 illustrates the return content process.

FIG. 17 illustrates the complete transaction process.

FIG. 18 illustrates the online return affidavit process.

FIG. 19 illustrates an examplary user interface for certification.

FIG. 20 illustrates the relationship between infrastructure costs and the number of users.

FIG. 21 shows the basic structure of a copy-protected disc.

### DETAILED DESCRIPTION OF THE INVENTION

The best way to describe EZTakes is to provide an example of how a typical EZTakes customer might use it. For the purpose of this example, we will simply call this customer Joe.

A Sample Customer

Joe is a consumer that owns a PC with a 180 gigabyte hard drive and a DVD burner. This computer is connected to the Internet via a high-speed broadband service that Joe rents from his cable company (NOTE: A broadband connection from any provider would suffice). Joe also owns a DVD player that is located in his family room and he is an avid movie buff. His household, which includes Joe's wife, a son and a daughter, goes through an average of about one DVD each week. Joe has recently set up an additional DVD player in the master bedroom and has just purchased a new minivan that came with a DVD player as a standard option. Joe selected the DVD option for the minivan because he thought it would be quite effective in entertaining his two children on family trips. There is a Microsoft Xbox in his son's bedroom and a Sony PlayStation 2 game console in his daughter's bedroom, both of which are capable of playing standard DVDs. Joe's employer has also provided him with notebook computer so he can work at home and while on business trips. Like many notebooks sold today, Joe's can play DVDs.

Getting Started

Having heard of EZTakes from a friend, Joe uses a Web browser to access the EZTakes.com Web site. This Web site provides a rich user interface for selecting content. As can be expected of a film buff like Joe, he is interested in movies for rent and/or purchase. The EZTakes Web site not only allows Joe to browse and search for movies, but also enables him to create a user profile, which will enable EZTakes to automatically recommend movies to Joe, let Joe view previews and partake in “community activities” such as rating movies he has seen and to exchange comments and recommendations with other EZTakes users.

If Joe decides to do business with EZTakes by renting or purchasing movies, he registers himself with the service and downloads the EZTakes client software. The EZTakes client software can create a Personal Content Store for Joe from which he can select movies to rent or purchase. The client software also enables Joe's computer to function as a peer server on the EZTakes peer network, which is described in further detail in a later part of this document.

After installing the EZTakes client software, Joe can browse the available movies by using a standard Web. Joe can define the movies that he might like to rent and/or buy. Joe can create his initial profile after installing the client software and then update it periodically thereafter. Joe could decide to update his profile, for example, on a monthly basis or more frequently, depending on his preference. Joe can also edit his profile and change his preferences while away from home by using the pure Web browser interface offered by EZTakes. This feature enables Joe to remotely control what is downloaded to his Personal Content Store.

Joe needs also to allocate the amount of hard disk storage on his computer that he wishes to set aside to store movies downloaded into his Personal Content Store by EZTakes. In this example, Joe decides to allocate 20% of his computer's storage capacity, or 36 gigabytes out of his 180 gigabyte hard disk. This amount of disk space will enable EZTakes to store several DVD-quality movies at a time, or up to about fifty movies at VCD-quality, which is roughly the same quality as VHS.

The EZTakes software runs a configuration test that automatically attempts to discover the capabilities of Joe's computer, such as the speed of his Internet connection, how much space is available on its hard drive and whether or not his computer has DVD and/or CD burning capability. EZTakes also enables Joe to download one or more sample videos that he could use to burn and test CDs and/or DVDs with his home entertainment equipment. A test movie can provide a secondary function of being a “how-to” video that introduces users to the EZTakes service and provide basic instructions on how to use it. This test is called the burn and return test.

EZTakes Personal Content Store

Once Joe's preferences have been defined, the EZTakes software begins to download the appropriate movies from the EZTakes peer network. The purpose is to “stock” Joe's personal content store with an inventory of as many movies as possible, given the allocated disk space. The EZTakes service accomplishes this in a very efficient manner by leveraging the EZTakes peer network.

An Earlier Generation of Peer-to-Peer Networking

Many are familiar with a less advanced peer network that was known as Napster. The first version of that service, which was launched and then shut down due to litigation several years ago, enabled users to search for a music file by querying against the Napster server, which would return a list of available music files located on other users' computers that were participating in the Napster network. A Napster user could then download the music file directly from another Napster user, or “peer”. While EZTakes is similar in that it uses a network of peer computers, it is also different in some very important ways, which are described in the following paragraphs.

Getting Content via EZTakes

Let's assume that one of the movies that Joe has selected to rent is Gladiator. Instead of downloading the movie in one file from one peer, the EZTakes software running on Joe's computer automatically and simultaneously downloads “parts” of the movie from the available peer servers on the network. This approach dramatically improves the EZTakes network's capacity and efficiency since it can fully saturate the bandwidth of Joe's broadband Internet connection. Moreover, the download operation is not dependant on any one peer server remaining available. Because EZTakes does not need a traditional server-to-client connection, a very large network can be served by a relatively low cost EZTakes server configuration. Since any EZTakes client (e.g. Joe's computer) can also function as a peer server to other EZTakes clients, the capacity to serve any particular piece of content actually grows in direct relation to the demand for that content on the EZTakes network.

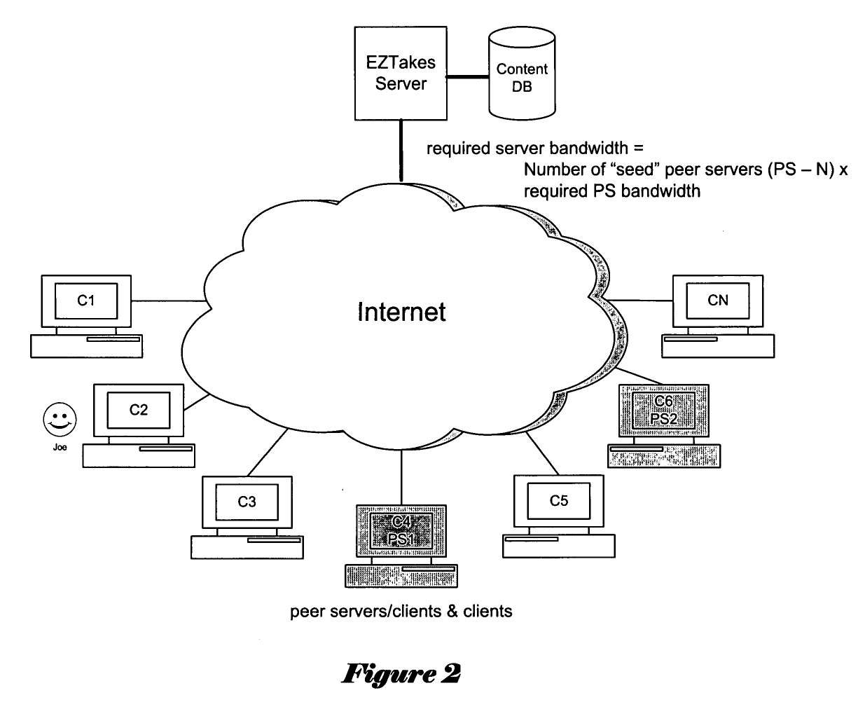

FIG. 2 illustrates how the EZTakes network functions. As indicated in FIG. 2, clients on the EZTakes network can also serve as peer servers (shown shaded). For example, client 4 (C4) is also peer server 1 (PS1) and client 6 (C6) is also peer server 2 (PS2). When the EZTakes service makes Gladiator available on the EZTakes network, the service does not attempt to download directly to Joe and all other clients that are requesting the movie. Instead, it downloads Gladiator to the “seed” peer servers, PS1 and PS2. The seed peer servers propagate Gladiator to other peer servers and/or clients. For the purpose of simplifying this example, assume that PS1 and PS2 are the only peer servers on the network. Consequently, Joe's computer, C2, would download Gladiator in two parts, half from PS1 and the other half from PS2. This type of configuration makes better use of available bandwidth. For example, if for some reason the download from one peer server is temporarily interrupted or simply slows down, the download from another peer server can continue without being negatively impacted, or even increase to take advantage of the spare capacity. Moreover, when one considers that in an actual implementation there may be many more peer servers than the two in our example, it becomes clear that this approach to content distribution inherently makes better use of the bandwidth available on Joe's broadband Internet connection.

EZTakes is also different from older generation peer-to-peer networks in that the service ensures that EZTakes customers, like Joe, pay content owners for the use of their content assets. EZTakes maintains control over the download processes, keeping track of which clients can and are serving and downloading specific pieces of content. EZTakes does this by employing a sophisticated algorithm for peer networking and layering digital rights management technology on top of this algorithm, such as the Bittorrent peer distribution algorithm (see http://bitconjurer.org/BitTorrent/), which is an open source project distributed under the very flexible “MIT” license. Other open source projects for peer networking or even proprietary commercial products could also be used in the future in place of or along with Bittorrent.

Over time, Joe's Personal Content Store becomes populated with Gladiator and other movies that he has pre-selected. The EZTakes software constantly runs as a “background” process (in a similar way to virus scanning software) and concentrates on downloading more and more parts of Gladiator. EZTakes can detect periods when Joe's computer and Internet connection are not being utilized by Joe or other members of his household and does it's best to take advantage of the downtime to get as much content as possible. Joe's installation of EZTakes typically does most of its work between midnight and 7 am, which is when the entire family is usually asleep. This approach is similar to that of disk de-fragmentation software, which frequently tries to do its work during periods that will not interfere with users. This works well for Joe because like most broadband users, he leaves his computer on and connected to the Internet just about all the time. This gives Joe the advantage of not having to boot his computer and explicitly connect to the Internet several times a day. Joe is not penalized for leaving his connection open since his cable company charges a flat monthly fee for the service.

It is also possible for Joe to allow the EZTakes service to automatically download content to his computer based on his profile and what EZTakes thinks he would like. When, for example, Joe wishes to rent a movie, he can use the EZTakes client software to browse the movies that have been previously downloaded. At the same time, he can watch previews as well as read reviews by professional critics and other EZTakes users.

Renting and Using Pre-Downloaded Content

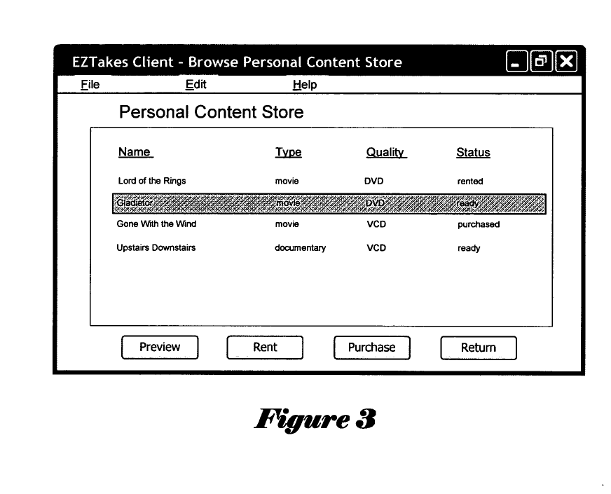

Joe selects the movie that he wants to see from his personal content store. FIG. 3 illustrates an exemplary user interface. The user interface might look something like that shown in FIG. 3, although actual implementations are likely look significantly different from the sample.

The preceding sample illustration shows that the content called Gladiator is selected in the personal content store. From here, Joe could view a preview and/or decide if he wants to rent or purchase the movie, which can be accomplished by clicking on the corresponding buttons. If the movie had been previously rented, the Return button would also be enabled. If Joe decided to rent Gladiator, he might be presented with several options.

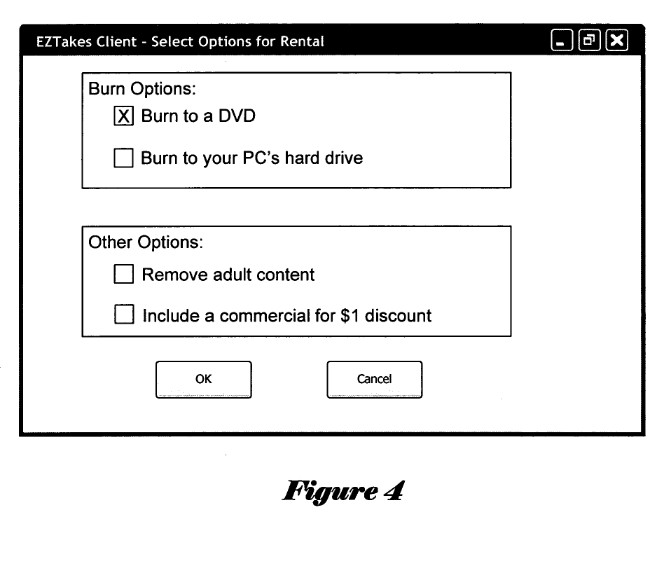

FIG. 4 shows an options window. As shown in FIG. 4, Joe has selected to rent Gladiator. By choosing the options (see checkboxes) selected in example shown in FIG. 4, Joe would then burn the rental to a DVD. Please note that there are several other options that EZTakes could provide to Joe at this point, such as whether or not he wants adult content (i.e. sex, foul language, violence, etc.) edited out of the content. He could also select to have a commercial included in the movie, which in this example would reduce the rental fee by $1. The flexibility that this example demonstrates is possible because EZTakes can make changes to content just before it burns it. Licensing and other business considerations may impact actual options provided to customers. The preceding examples simply show some of the possibilities.

When Joe rents or buys Gladiator by using EZTakes, the software would automatically retrieve an access key from the EZTakes server that enables the client software to “unlock” the movie content file. Even though the time consuming task of downloading the movie file is complete, the movie is not playable until the key is retrieved and used by the EZTakes client to unlock the file. The current direction that Artio is taking to protect the content is to implement a proprietary DRM algorithm that leverages the EZTakes peer network. This algorithm should be fast so as not to cause Joe (or other EZTakes customers) inconvenience. It is important to note, however, that EZTakes may deploy off-the-shelf DRM technology from companies such as Microsoft and Real Networks in the future in addition to or instead of its proprietary DRM implementation.

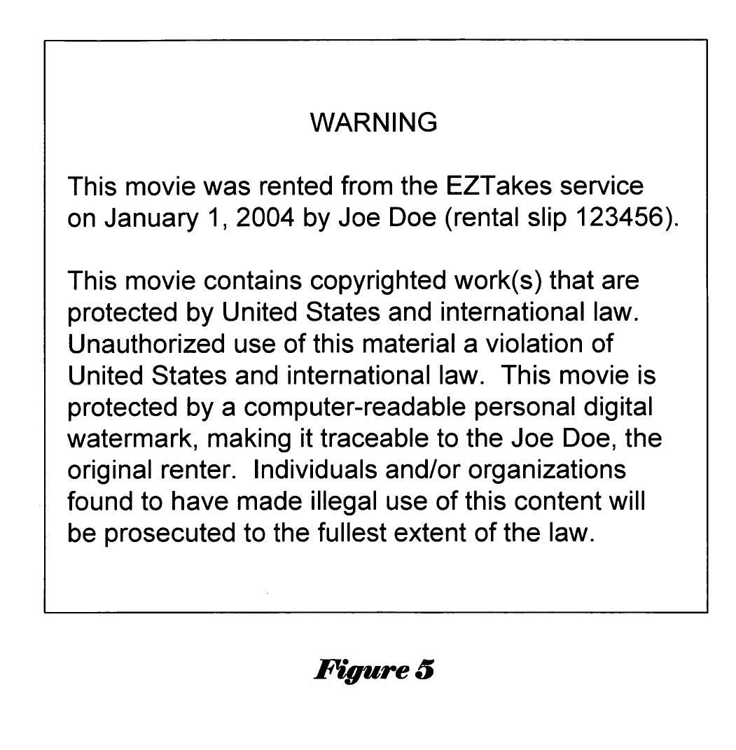

The movie file for Gladiator in Joe's Personal Content Store is unlocked at the point that the EZTakes software burns it to a DVD. Alternatively, the movie can be unlocked and played on Joe's computer, if he decides to view it that way. Another important point is that Joe's copy of Gladiator, as well as any content purchased or rented via the EZTakes service, contains at least one personal digital watermark (PDW). This can include a tamper-resistant watermark that would be removed by expending effort and technical expertise, as well as an obvious watermark, such as a splash screen at the beginning of the movie. FIG. 5 shows text that could, for example, be shown in an initial splash screen.

The human-readable watermark shown in FIG. 5 would serve to remind Joe of the proper and legal use of the movie and to make it obvious to him that his specific copy of Gladiator is traceable back to him should, for example, it be found at some point in the future on an illegal file-sharing network. The technical watermark makes it easier for an automated system to trace misused content and provides an additional hurdle for users that may attempt to make the file non-traceable.

Once Joe has burned the movie to a DVD, he can (1) play it on the DVD players located in the family room or his bedroom; (2) play it on his home computer or take it on a business trip to be played on his notebook; (3) take it on a family vacation so that his children can view it while riding in the minivan; or (4) give it to one of his children to play on their Xbox or PlayStation 2 game consoles. This flexibility and portability of content is a key advantage of the EZTakes service.

Additional Options

Joe also has a number of other options for using the movie he has rented or purchased. In addition to creating his version of Gladiator, he can also create one or more additional copies (perhaps for an incremental fee) for other members of his family. He may even choose to create a G-rated version for his children with sex and/or violence scenes removed (Of course, Gladiator would be about five minutes long after removing the violence). Additionally, when Joe creates his DVD, he may elect to have targeted commercials (i.e. selected based on his profile and other criteria) included in the movie, which may make him eligible for a reduction in the rental fee. The resultant DVD could be created to exploit the DVD feature that prevents viewers from fast-forwarding through commercial portions of the DVD. For efficiency, EZTakes could have pre-downloaded the appropriate commercials beforehand and dynamically added them to the movie.

Burn and Return

Unlike traditional video store rentals, EZTakes is not encumbered by inventory management requirements and costs. Consequently, rental periods can be very flexible. The movie Joe rents, for example, could have a rental period of one month and cost some amount less than a traditional video store rental. Once Joe is finished with his rental, all he needs to do is insert the DVD into his computer and run the return function provided by the EZTakes client. The return function checks the digital watermark on the DVD to ensure that it is the original copy and then overwrites (i.e. destroys) the movie content file on the DVD. This feature of EZTakes is referred to as burn and return.

In some cases, EZTakes may make allowances for customers who loose or otherwise can't destroy the rented content (e.g. somebody broke the disk). As an exception, EZTakes may let Joe create an on-line return affidavit certifying that he destroyed the movie he rented. During this process, Joe would be reminded that the rented content was digitally watermarked for him personally and thus it is traceable to him. If Joe is unable to verifiably destroy rented content more than a reasonable number of times, however, Joe may need to purchase the rented content.

Philosophical Approach to Watermarks & Digital Rights Management

The creators of EZTakes adhere to the philosophy that one should never think that digital watermarking and DRM technologies are foolproof. Indeed, many so-called “unbreakable” technologies have been compromised fairly easily. Moreover, it is also possible that stronger, as yet unbroken, technologies can one day be compromised via any number of techniques, ranging from a mathematical revelation exposing the previously unknown weakness in an algorithm to low-tech “social engineering” attacks that may be as simple as tricking users into revealing passwords or blackmailing a system administrator. Simply stated, the goal of EZTakes' approach to DRM is to make it harder for a hacker to use technical means to compromise the content delivered via EZTakes than it would be to buy or rent the content from a retail outfit. The service also relies on the principal that people like Joe are generally honest and are willing to pay for content, provided that they get additional value from a legal service like EZTakes. In order to reinforce honest behavior, EZTakes gently and regularly reminds customers of the appropriate use and traceable nature of its content.

Rent and Buy Option

Of course, Joe may wish to purchase a permanent copy of Gladiator at some point after he rents the movie. The EZTakes software can also perform this transaction. If Joe decides to buy the movie, the appropriate incremental charge would be applied to his account. The EZTakes software would then enable Joe to print an appropriate label for the Gladiator DVD case. Moreover, in some cases purchasing the movie may allow Joe to add additional content, such as director comments, extended versions and so on.

Freeing Space for Additional Content

When Joe is finished with Gladiator, the space it used in his Personal Content Store can be overwritten with additional content. EZTakes will download additional content automatically based on the picks and preferences Joe defined by using the EZTakes software, interacting with the EZTakes service.

Pre-Ordering

Another useful feature of EZTakes is pre-ordering of content that is not yet available. Joe, could, for example decide that he liked Gladiator so much that he wants to see the sequel as soon as possible. He could then order Gladiator II, even though it hasn't been released on DVD yet (it may even still be playing in theaters when Joe pre-orders it). Once Gladiator II becomes available through EZTakes, the service would automatically download it to Joe's Personal Content Store on his computer.

Why Joe Likes EZTakes

After using EZTakes to rent Gladiator and several other movies, Joe is comfortable with the service and it soon becomes his preferred way of renting and purchasing not only movies, but other content, such as the classic TV shows like The Honeymooners and one of Joe's favorite episodes of a science TV show that he once saw on public television entitled Nova.

Joe cites several reasons for liking EZTakes. For example, the service saves him time by eliminating trips to the video store. And since EZTakes's inventory can be replicated electronically, it is not subject to stock-outs that often plague traditional video rental stores and mail order services. While Joe's Personal Content Store may have a smaller selection than a large physical store, the up to 50 movies it can store (NOTE: It can be more than 50 movies; it is limited by the amount of free disk space)_are much more likely to be of interest to Joe. Besides additional titles are constantly and automatically rotated onto his computer.

EZTakes also offers several advantages over other electronic download services. First of all, EZTakes offers high-quality content. When Joe wishes to rent movies that contain a great deal of special effects, such as the Lord of the Rings, he strongly prefers DVD quality. Since Joe can burn a movie rented or purchased via EZTakes onto DVD media, he has much greater flexibility and portability, which enables him to play the movie on any one of a number of DVD-enabled devices that he and his family have access to. Indeed, EZTakes' DVD-oriented approach does not force Joe to take the risk of purchasing additional products or to do a great deal of work in order to connect his home computer to devices on which he would like to view downloaded content. Having dealt with some of the complicated rules and restrictions of other content download services, Joe greatly appreciates EZTakes' flexible, simplified and non-intrusive approach.

The Current Implementation of EZTakes

The current implementation of EZTakes includes a Web site on which video titles are published. Customers can browse the Web site with a standard Web browser, such as Microsoft Internet Explorer or FireFox. The first time a customer downloads content, the customer is prompted to install the EZTakes client application, which is currently called the EZTakes Download Manager. After a customer selects content on the EZTakes Web site, the browser is directed to a page that automatically launches the EZTakes Download Manager, which provides functions that enable the customer to download, unlock and burn content. The final result is a disc, which currently can be a recordable DVD or a VCD. These discs can play in most standard DVD players. In addition, the contents of a disc will contain one of more digital watermarks. These watermarks can be human-readable (e.g. a splash screen reminding the customer of the terms & conditions) and/or computer-readable (e.g. marks embedded in the video stream or other parts of the DVD, such as a subtitle track). Since the watermarks cannot be removed without some sort of computer program, they diminish the probability that unauthorized copies of the content will be made. Another important point is that by using watermarks that do not change the fundamental nature of the DVD/VCD structure, new types of watermarks can be added at any time. Consequently, even a user that has discovered how to remove EZTakes watermarks cannot be certain that a new watermark hasn't just been added by the service.

For distributing content, EZTakes currently uses a “hybrid peer network.” The EZTakes peer servers are not currently running on client machines. Instead they run on multiple servers at a Web hosting service. Since these servers can run in multiple geographically dispersed data centers, EZTakes already enjoys much of the cost and scalability advantages discussed in this document.

EZTakes Data Flow Diagrams

This section provides a comprehensive set of data flow diagrams that describe what happens, from a client perspective, when an individual enrolls in and uses the EZTakes service. The reader will likely find it useful to refer back to the appropriate diagrams while reading the corresponding narratives.

Setup

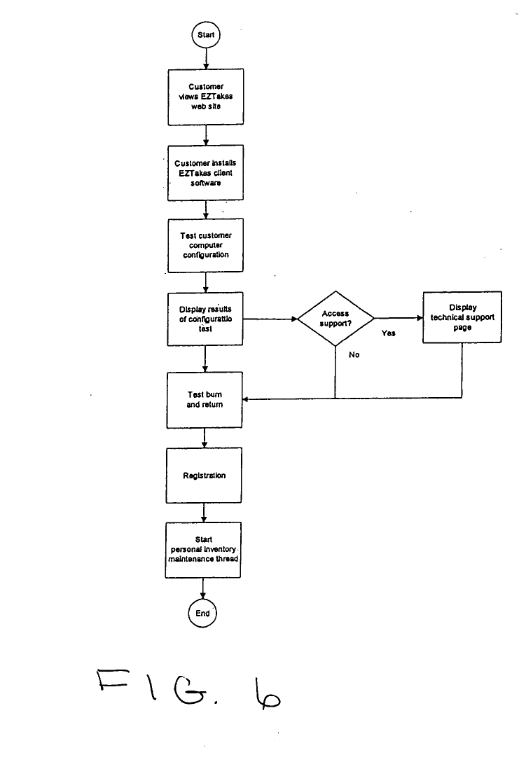

In order for a customer to use EZTakes, she first needs to perform the Setup process. FIG. 6 illustrates the Setup process. FIG. 6 shows that in order to setup EZTakes, the customer needs first to access the EZTakes Web site. This can be accomplished by using a standard Web browser, such as Microsoft's Internet Explorer. This Web site provides detailed information about the EZTakes service, including terms and conditions for using the service and customer prerequisites (e.g. recommended home computer configuration and Internet connection bandwidth). The site also includes instructions and functions that enable potential customers to download the EZTakes client software that run of the customer's computer.

After the customer downloads and installs the EZTakes client software, the first thing the software does is check the configuration of the computer that it is running on. This information allows the EZTakes software to run smoothly and provide the optimum services possible, given the capabilities and limitations of the computer used to interface with the service. For example, the preferred configuration is for a computer with a significant amount of available hard drive space (e.g. 180 GB or more), a re-writable DVD or CD burner and a high speed Internet connection. Less capable configurations will limit how the customer can use the service.

During setup, part of the available hard drive space on the customer's computer will be allocated to the customer's personal content store. The more space allocated, the more content that EZTakes can pre-download to the customer's computer and, therefore, the more content that will be available to select from when the customer rents of buys content from the store. EZTakes can provide a default setting for the amount of space initially allocated to the personal content store. Moreover, customers may be allowed to change these settings during install and/or as part of preference maintenance.

After running the configuration test, the EZTakes client software displays the results of the test. This will include information about what services the customer will be able to use. For example, if the customer does not have a DVD burner, she will not be able to rent or purchase DVD-quality content for burning onto a physical DVD. She may, however, be able to rent or purchase DVD-quality content that can be played on her computer. If her computer has a CD burner, she can still purchase lower quality VCD-quality content that for burning to a CD, which many DVD systems can play.

The next task that the customer should perform as part of setup is to test burn and return, the process that enables customers to return rental content that was previously burned to re-writable media, such as a re-writable DVD or CD. The customer runs this test before renting content. Although a customer could simply “burn” content to a local hard drive, she could not take full advantage of it (e.g. view it on a home entertainment system's DVD player) unless she can burn it to the appropriate portable media. The burn and return test is described in a later subsection (see Test Burn and Return).

After a burn and return test is attempted, the customer registers with the EZTakes service (see Registration). After registering, the EZTakes software will automatically start the personal inventory maintenance tread. This process (see Personal Inventory Maintenance) runs as a “thread” because it executes continuously and, therefore, simultaneously with other EZTakes functions. As described in the corresponding subsection, the Personal Inventory Maintenance process continually manages the inventory in the customers' personal content store to ensure that it contains the best selection of content that she may wish to purchase or rent.

Test Burn and Return

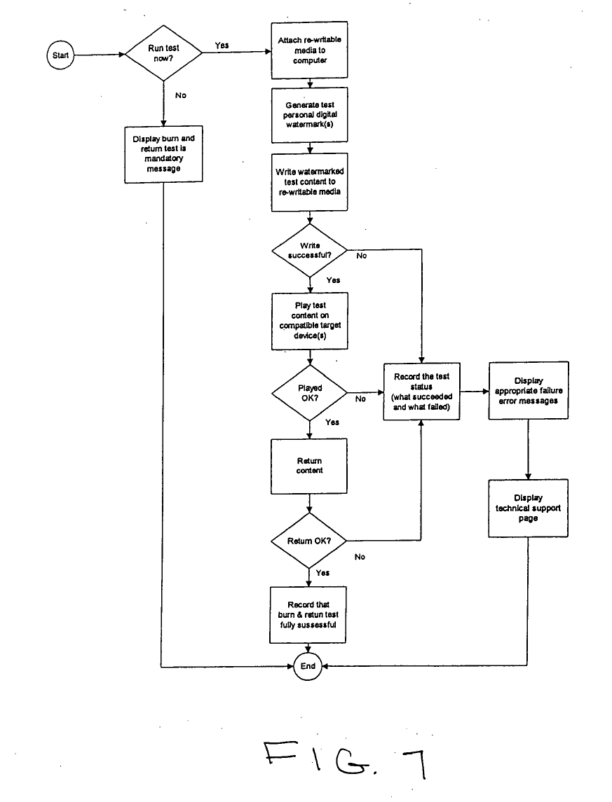

The purpose of the burn and return test is to ensure that the customer is not subject to a nasty surprise when she attempts to rent or purchase content. FIG. 7 illustrates the test burn and return process. The burn and return test involves the customer performing an “end-to-end” test: burn content, play the content on a target device and then return the content by using the EZTakes client software. Since there are many possible computer configurations, there may be several different types of burn and return tests. At the highest functioning level, a customer's computer would have a re-writable DVD drive and several compatible devices. In that example, the customer would burn sample content onto a re-writable DVD, then attempt to play the content on any number of compatible target devices (e.g. DVD players, game consoles, etc.), and finally attempt to return the content by using the EZTakes client return function, which would erase the content from the DVD.

At a minimum, a client's computer may not have any CD/DVD burning capability. In that case, the only re-writable media available could simply be the local hard disk. This type of customers can still rent content from EZTakes, but the customer could then only play the rented content directly in the computer running the EZTakes client software. In order for an EZTakes customer to rent content on DVD media, the media using for burning content needs to be re-writable. That is because EZTakes cannot verifiably return (i.e. erase) content when it is on non-erasable media (see Return Content subsection).

The current implementation provides a burn test similar to the one described in this section; however, it does not include the return portion of the test since the rental option has not be fully tested and will not be released to the public in the first phase of the EZTakes service.

Registration

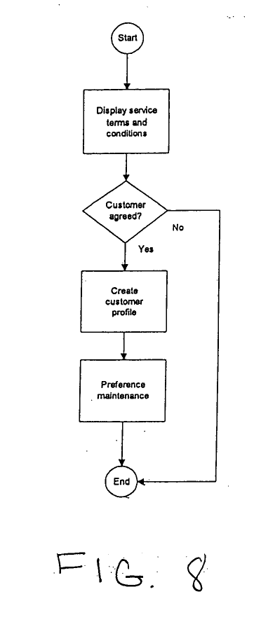

The registration process runs as part of the first time setup. During this process, the customer provides personal and preference information to the EZTakes service. FIG. 8 illustrates the registration process. The first thing that happens during registration is that the terms and conditions for using the EZTakes service are displayed to the customer. The customer explicitly agrees to these terms in order to continue with registration. Please note that the customer may also agree to the EZTakes service terms and conditions when she downloads the EZTakes software and/or installed it.

In the next step, a customer profile containing customer personal information, such as name, address and billing information is provided by the customer and recorded by EZTakes. As part of creating a customer profile the customer may be allowed to choose from a number of payment options. These options can include:

(1) Subscription—The customer could rent or purchase some volume of content for a set periodic (e.g. monthly) fee.

(2) Pay as you go—The customer could pay for each individual rental or purchase without having the pay a periodic subscription fee. While this option enables the customer to avoid committing to a monthly fee, the rental and purchase prices from particular items are likely to be higher.

(3) Combination subscription and pay-as-you-go—The customer pays a smaller monthly fee than the pure subscription, but also a lower per item fee than the pure pay-as-you-go model.

EZTakses may implement variations of one or all of the preceding payment options. Licensing terms negotiated with content owners will have an impact on the financial options provided to customers, as will other business and technical considerations.

In addition to customer fees, advertising may be an important revenue stream for EZTakes. Ad space can be rented, for example, in the EZTakes client. In addition, Artio Systems is working on technology that would enable the EZTakes client to include targeted commercials in the content at the time it is burned. As part of creating a profile, customers may be given the option to “opt-in” for these commercials, which may make the customer eligible for incentives, such as discounts on certain fees.

The final step in the registration process happens when the preference maintenance process runs. This process is described in another subsection (see Preference Maintenance).

Preference Maintenance

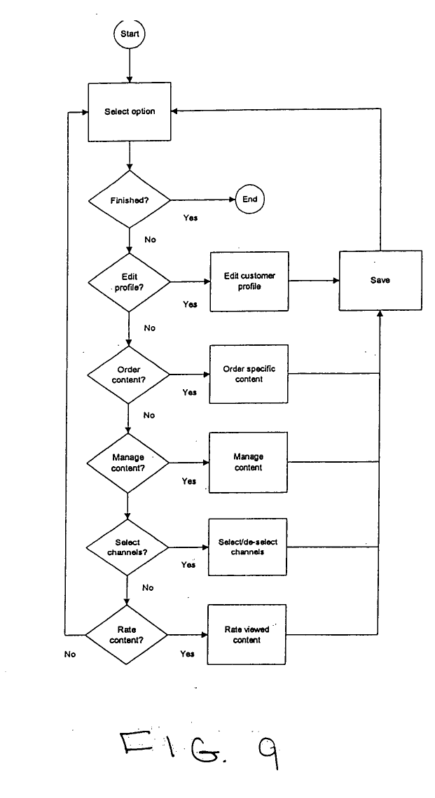

The preference maintenance process enables a customer to define her preferences to the EZTakes service. For example, this could take the form of explicitly ordering specific content (i.e. Send me Lord of the Rings: The Two Towers as soon as possible), or simply defining likes and dislikes so that the EZTakes service itself can identify content to either suggest to the customer, or even automatically download to the customer's personal content store. FIG. 9 illustrates the Preference Maintenance process. It bears mentioning that in the manage content step shown in the preceding diagram, the customer may be allowed to change the amount of hard drive space allocated to her personal content store. If for example, the customer wishes to order more content than the space already allocated will permit, she will either need to increase the space allocated to the personal content store, or, if possible, specify a lower quality for the content to be downloaded into the store. It is important to note that a VCD-quality version of a video needs significantly less hard drive space than a DVD-quality version of the same video. In the current implementation of EZTakes, the customer orders specific content.

Personal Inventory Maintenance

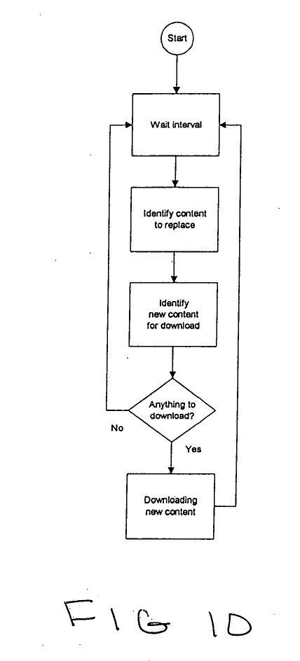

The personal inventory maintenance process is not necessarily synchronized with other EZTakes processes; however, it runs before a customer can begin renting or purchasing content via EZTakes. FIG. 10 illustrates the personal inventory maintenance process. It is important to note that the personal inventory maintenance process runs continually. This is apparent when you look closely at FIG. 10. The first step of the process is simply to wait an interval of time. This interval could be just about any reasonable length of time, such as a tenth of a second or a even month. The intervals used will depend on what is most efficient and effective for a given circumstance.

Next, EZTakes identifies the content in the customer's personal content store that can or should be replaced with new content (see Identify Content to Replace subsection). The personal inventory maintenance process also identifies the new content that can or should be downloaded to the EZTakes customer's personal content store (see Identify New Content for Download subsection). As mentioned previously in this document, the amount of content that EZTakes can download to a customer's computer is limited by the amount of hard drive space allocated for the personal content store.

Another important part of this process is to determine if any download action should be taken. The answer to this conditional will be “yes” when EZTakes calculates that there is content identified for download that has a higher priory than content that has already been downloaded into the customer's personal content store. The priority is calculated by EZTakes is based on the customer profile, preferences, rental/purchase history and other criteria. To give one simple example, EZTakes would probably calculate that it makes sense to delete Gladiator and download Lord of the Rings into the space freed up if the customer has already rented and returned Gladiator and has specifically ordered Lord of the Rings.

If a customer had chosen to allow one or more commercials to be included in content that is rented or purchased, the EZTakes client could also download new commercials during the download step of personal inventory maintenance process. When EZTakes unlocks, watermarks and burns content, it could also dynamically merge commercials into the content, if appropriate.

Identify Content to Replace

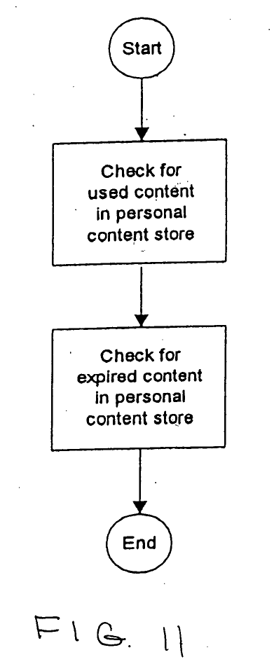

The personal inventory maintenance process invokes the identify content to replace process. FIG. 11 illustrates the identify content to replace process. As shown in the preceding diagram, the identify content to replace process currently performs two steps. The first is to check for “used” content in the personal content store. Used content is content that has already been purchased and/or rented by the customer. The next step checks for expired content, which is content that has been in the content store for a long period of time (or at least a relatively long period of time), but may not have been purchased or rented.

Identify New Content for Download

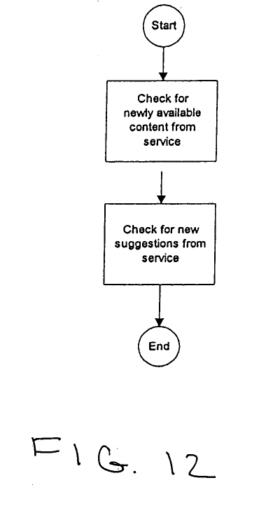

The personal inventory maintenance function also calls the identify new content for download process. FIG. 12 illustrates the identify new content for download process. As indicated in FIG. 12, the identify new content for download process performs two main tasks. First it checks for newly available content from EZTakes. For example, new content may be available that the customer has specifically ordered.

In the next step, EZTakes may calculate that a customer has a high potential to like (and therefore is likely to rent of buy) some newly available content. EZTakes makes this decision based on the customer's profile, preferences and/or previous purchase/rental behavior.

Normal Operation

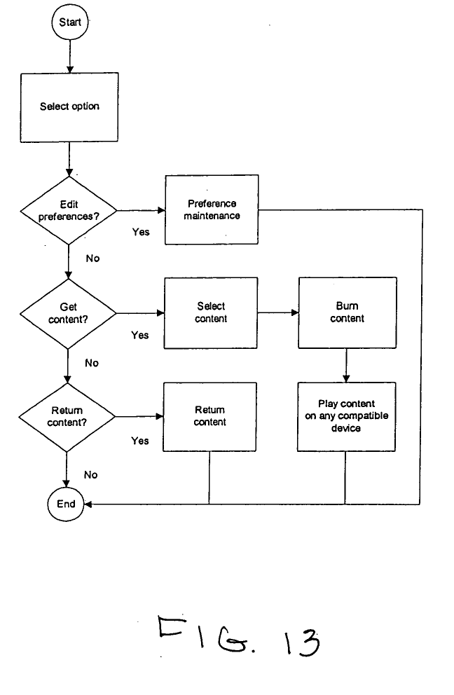

The normal operation process describes how the customer would interact with EZTakes on a day-to-day basis. FIG. 13 illustrates the normal operation process. As shown in FIG. 13, customers can choose from a number of options when they use EZTakes. They may wish to change their preferences, in which case the preference maintenance process would be invoked.

As part of normal operation, customers may wish to get content (i.e. rent or purchase content from their personal content store). As shown in the diagram, the customer would first need to select the content (see Select Content subsection) from the selection that was already downloaded into her personal content store. Next, she would burn the selected content (see Burn Content subsection) to a suitable media. It is important to note that the customer would not be charged for the rental or purchase until the burn content process is invoked.

Once the content has been burned, the customer can play the content on any compatible player. Some examples of player could be a standard DVD player, game console capable of playing DVDs, or even a computer with a DVD reader. It is important to note that EZTakes customers are not limited to DVD media. It is possible that customers may simply “burn” content to a local hard drive, which would probably be the case when the customer's computer is not capable of writing data to a suitable portable media.

In normal operation, a customer may also decide to return content (see Return Content subsection). This would typically occur when the customer has previously rented content, played it, and wishes to complete the rental transaction. It is important to note that customers need to return rented content at some point, or they could need to pay late fees or may eventually need to purchase the returned rented content that they do not return. One advantages of EZTakes, however, is that since it is not subject to most of the inventory carrying costs and constraints of other content rental models, the rental periods could be quite flexible.

Select Content

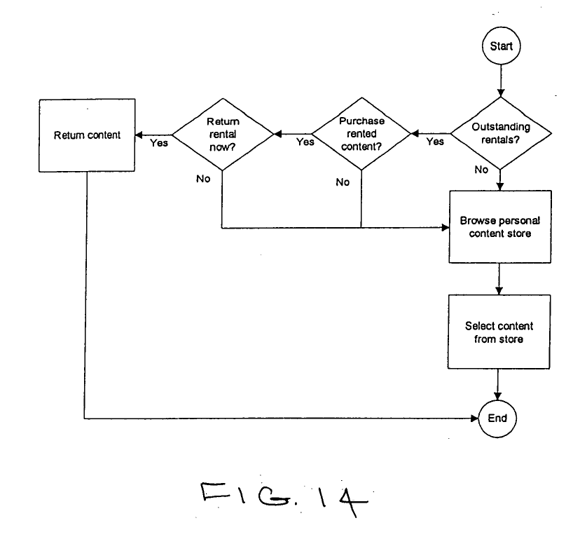

The select content process is typically invoked after initial setup and during normal operation of EZTakes. FIG. 14 illustrates the select content process. As shown in the preceding diagram, there are two basic situations that involve selecting content: (1) when the customer wishes to purchase a permanent copy of content that was previously rented; and (2) when a customer wished to select content for purchase or rental from the selection of previously downloaded content resident in her personal content store.

If a customer has an outstanding rental that she wants to purchase, the customer may wish to “return” the rental before purchasing a permanent copy. Should the customer wish to return a rental before making a purchase, then the return content process (see Return Content subsection) would be invoked. If the customer did not wish to return a rental before making a purchase, she would at least need to identify which rental she wants to purchase since there may be multiple previous rentals.

If the customer wishes to select new content from her personal content store, the she can browse the available selection by utilizing the user interface provided by EZTakes. Once the desired content is located in the personal content store, the user can select it.

Burn Content

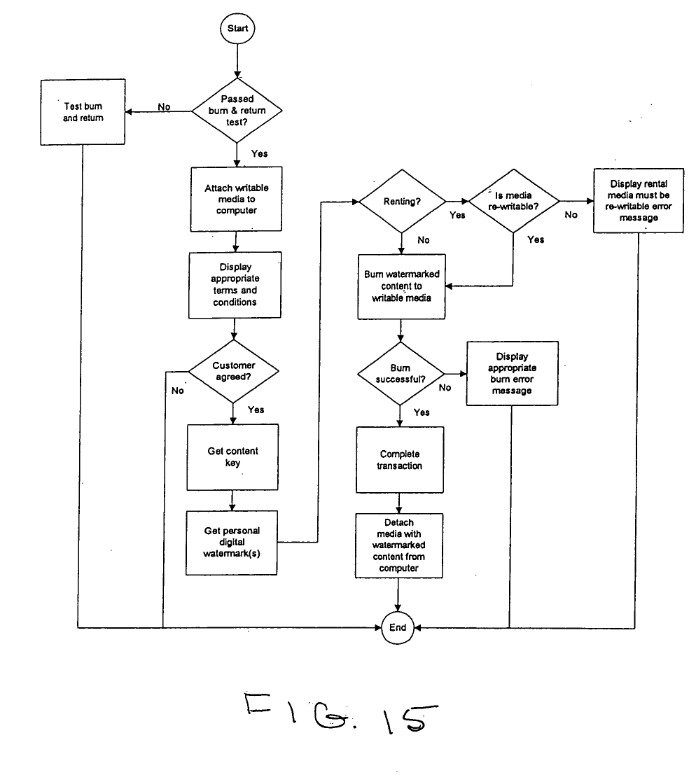

The burn content process runs whenever a customer rents or purchases content from her personal content store. FIG. 15 illustrates the burn content process. Before content can be burned, the customer runs a burn and return test on the computer running the EZTakes software. This enables EZTakes to learn the capabilities of the computer and to determine the compatibility of her computer with the target equipment on which content is to be played. As shown in the diagram, if the customer has not run a burn and return test, she will be given the option of running one. If the customer does not elect to run the test, she is reminded that the test is mandatory and the process stops.

If the customer has already run a burn and return test, she is presented with a message listing the terms and conditions of for burning the selected content. These terms and conditions will remind the customer of the appropriate and legal use of the content. The terms and conditions may be different, depending on whether the transaction involves a rental or purchase, or even depending on the content. The customer explicitly agrees to the terms and conditions before proceeding to the next step.

After the customer agrees to the terms and conditions, the terms and conditions, the EZTakes client software contacts the EZTakes service in order to retrieve the appropriate “key” or “keys” needed to unlock the content residing in the customer's personal content store. This could be accomplished when the EZTakes client makes a request over a secure communications link to an EZTakes server machine, which would be running in a remote data center setup by EZTakes. On a basic level, a key can be considered a secret known only to the EZTakes service (as opposed to the EZTakes client). This key can be expresses as a formula or as a string of characters that could be input into a cryptographic algorithm, making it possible for the EZTakes client software to transform (AKA unlock) the downloaded content data into a playable format.

It is important to note that that actual implementation used to unlock the EZTakes content may take several forms. It could employ an off-the-shelf digital rights management software package or algorithm licensed by Artio Systems; or it could utilize a proprietary algorithm implemented by Artio that may leverage the EZTakes peer network (see discussion in the Other Potential Advantages subsection of the Miscellaneous Topics section). For added protection against misuse of content (e.g. hacking the personal content store), it may be possible to utilize multiple keys.

After obtaining the key(s) needed to make content playable, the EZTakes client software obtains one or more personal digital watermarks (PDWs) that will be used to make the burned content unique. Doing this serves two purposes. First, personalizing content with a PDW enables EZTakes, content owners, or potentially anyone else for that matter to trace misused content. For example, if rented content shows up on an illegal file swapping site, the PDW will make it possible to trace it back to the original renter, which would facilitate an investigation into what happened and support any appropriate legal or other action to be taken.

A second purpose of a PDW could be to provide the customer with a constant reminder of the appropriate and legal use the purchase and or rented content. This could be accomplished by including a human-readable PDW, which could, for example, be a “splash screen” shown at the beginning of a movie reminding the customer that they are not permitted to copy or resell the content (see A Customer Example subsection of The EZTakes Solution section).

After obtaining the PDWs, the EZTakes client determines whether or not the customer is renting or purchasing content. If the customer is renting content, she uses re-writable media. As previously mentioned, re-writable media is needed to rent content since the EZTakes return process verifiably erases the rented content. If the content is re-writable, EZTakes continues to the burn step. Alternatively, if the customer is attempting to purchase content, EZTakes will proceed to burn the content to any “writable” media, which could be write-once or re-writable. In most cases it is recommended that the customer use write-once media when purchasing a permanent copy since write-once media is thought to last longer than re-writable media and cannot accidentally be overwritten.

At the time the content is burned, the customer may be given the opportunity to select that commercials be included in the content. This option could also be set by default in the customer's profile. When burning content to a DVD, EZTakes could leverage the DVD capability that prevents viewers from fast forwarding through the commercial at the time of playback.

If the burn is successful, the next step is to complete the transaction (see Complete Transaction subsection) where the appropriate charges will be applied and the customer account will be updated. If the burn is not successful, the EZTakes software will display the appropriate error message(s). After the transaction is complete, the user may, if appropriate, detach the media containing the watermarked content from the computer.

Return Content

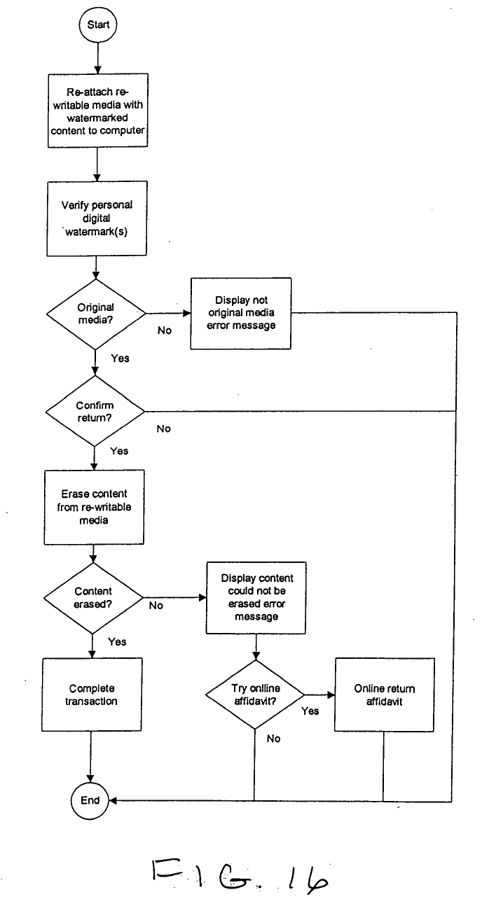

The first time the return content process runs is when as part of the test burn and return function. Thereafter it is run whenever a customer wants to return previously rented content. FIG. 16 illustrates the return content process. As illustrated in the preceding diagram, the customer first ensures that re-writable media is attached to the computer that is running the EZTakes client software. This could be, for example, a DVD burner with a blank re-writable DVD inserted in it.

In the next step, the EZTakes client software checks the personal digital watermark(s) on the content file to ensure that it is the original media onto which the rented content was burned. If it is indeed the original media, the EZTakes software erases the content. Before the content is erased, however, the customer is asked to confirm the return.

Once the EZTakes client has verifiably erased the content, the transaction is completed. This is accomplished by running the complete transaction process (see Complete Transaction subsection). If the content cannot be erased, an appropriate error message is displayed to the customer.

If for some reason it is impossible for a customer to return content, she may be able to use the online return affidavit function to complete a return rental transaction (see Online Return Affidavit subsection). It is important to note that customers need to return content by using the appropriate functions provided by EZTakes. Otherwise, they may be charged late fees or may possibly need to purchase a permanent copy of the relevant content.

Complete Transaction

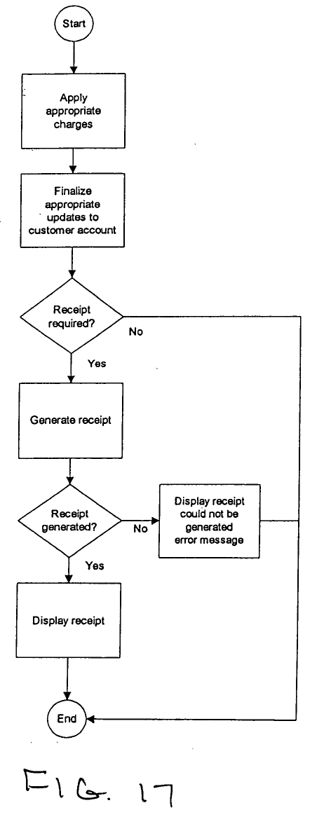

The complete transaction process is called from the return process and may be called from other processes. FIG. 17 illustrates the complete transaction process. When the complete transaction process runs, the appropriate charges are applied to the customer's account. To give some example, this could include purchase charges, rental fees, or late fees.

Updates to the customer's account are also finalized in this process (i.e. recorded in the permanent record maintained by the EZTakes service). It may record, for example, that a return transaction was successfully completed.

In most cases involving a financial transaction, a receipt would be needed. In that case, the last step in the complete transaction process happens when the receipt is displayed to the user.

Online Return Affidavit

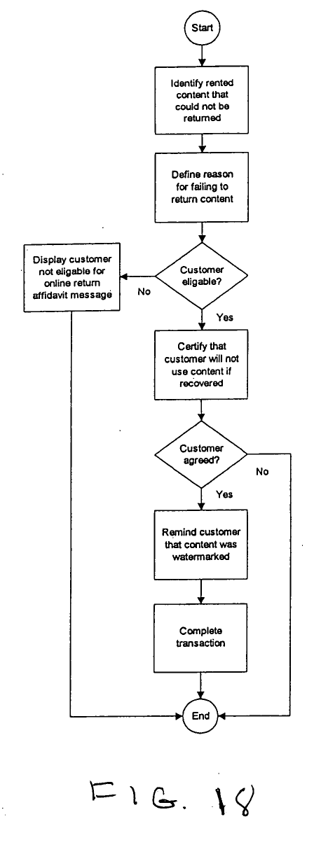

If a customer is unable to utilize the return content process for some reason, she may be able to use the online return affidavit process. For example, if a customer inadvertently destroys the rented media (e.g. someone stepped on and cracked the physical DVD), EZTakes might allow her to use the online affidavit process. FIG. 18 illustrates the online return affidavit process. As shown in FIG. 18, the customer first defines what rented content is being returned. Next, she provides a reason for using the online return affidavit process to return it (as opposed to using the return content process).

After defining the content to be returned and the reason for using the online return affidavit, EZTakes makes a decision as to whether or not the customer is eligible to use the feature. The primary reason for doing this is to prevent abuse. If, for example, the customer routinely uses this feature, EZTakes may stop offering it to that particular customer. In other words, EZTakes uses a frequency tolerance threshold for making the eligibility decision.

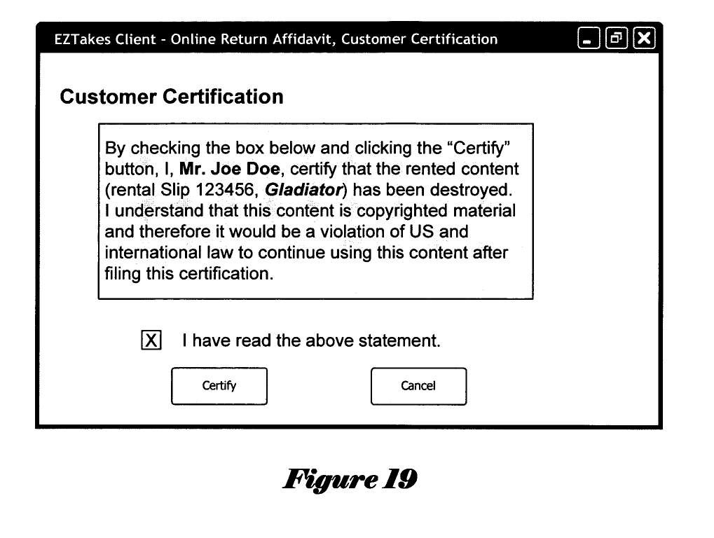

If EZTakes determines that the customer is eligible to use the online return affidavit, it requests that the customer to explicitly certify the reason for the return and that she understands that continuing to use the content would be illegal. FIG. 19 illustrates an examplary user interface for certification. After the customer certifies the return, EZTakes may remind her that the content contains one of more personal digital watermarks, which make the content traceable. The final step in the online return affidavit process happens when the complete transaction process is invoked.

Miscellaneous Topics

While the example of Joe, our sample EZTakes customer discussed in the previous section, should help you to understand a great deal about how EZTakes works, there are several other topics that merit discussion. Many of these topics are covered in this section.

Payment and Revenue Models

Several customer payment and revenue models for the EZTakes service could be implemented. These include, but are not limited to the following:

Pure Subscription—Customers pay a fee on a periodic basis (e.g. monthly) and are able to rent up to a specified number of movies during that period at no additional charge.

Pay-per-view—Customers pay for each piece of content they rent and/or buy via EZTakes.

Hybrid Subscription/Pay-per-view—Customers pay for a periodic subscription and a pay-per-view fee, which would be lower than the pure pay-per-view fee.

Advertising—It is possible for EZTakes to offer customers lower fees for just about any payment model, provided they are willing to allow EZTakes to include commercials in the content. Presumably, advertisers would pay higher per customer fees for the precision advertising possible through EZTakes by leveraging the dynamic nature of electronically delivered content and the EZTakes customer profile.

The preceding list is not exhaustive; however, it does provide some starting points for how EZTakes could realize financial returns from the innovative and superior services it offers. Additional opportunities should present themselves as the service and market matures.

Partnerships

Several partnership opportunities for EZTakes are apparent. Because EZTakes is designed to allow both the server and the client to be re-branded, third parties could provide the service under their own private label. For example, the organization that periodically hosts the “Northampton Film Festival” could provide a branded version of EZTakes and use it to create the “Virtual Northampton Film Festival”. The virtual and live events could be held simultaneously or at different times. Another example could be specialized TV channels, such as Comedy Central, which could offer a download of the EZTakes client from their Web site that will automatically set up a Comedy Central “EZTakes channel” area in the client. This type of partnership could provide these organizations with expanded revenue opportunities and also give EZTakes an opportunity to sell their customers additional content, which may involve adding additional channels to the EZTakes client (e.g. Since you already have EZTakes-Comedy Central, why not add EZTakes-Discovery?).

Another potentially valuable type of partnership for EZTakes could be with computer manufacturers and distributors. EZTakes software could come pre-installed on new computers, making it much easier for customers to get started using the service. These preinstalled versions might also include a few movies or other pieces of content as a special promotion.

Broadband providers, such as cable and telecom organizations, might also be interested in partnering with EZTakes since it takes advantage of broadband Internet connections. By adding value to these providers' services, EZTakes may increase customer retention and provide additional revenue opportunities. It might also be possible for EZTakes to partner with the manufacturers of more advanced set-top cable boxes (e.g. Motorola) in order to provides a version of EZTakes that could run on future generations of these products.

One of the fastest selling consumer electronic devices in Japan are DVD player/recorders that include a hard disk. Before long, many such devices will probably also include embedded operating systems such as Linux. As their devices become increasingly more like computers, consumer electronic manufacturers may come to see EZTakes as an ideal application to preinstall on their products.

Personal video recorders (PVRs), such as Tivo and ReplayTV, have been on the market for several years and have accumulated a slowly but consistently growing user base. These users are almost fanatically attached to the functionality provided by PVRs. Similar products, such as Microsoft's Home Media Center, have also entered the market. Companies like Microsoft and Tivo (via its Media Center option) are already providing application programming interfaces (APIs) that enable third parties to plug into their products. As these products become more popular, it will probably make sense for EZTakes to develop interfaces to them.

Content owners, ranging from large movie production companies to small independent filmmakers or even individuals, could be interested in using EZTakes to be more cost effective and provide rapid distribution of their digital assets.

Because the selection of EZTakes pre-downloaded content would be greater for customers that allocate more disk space, hard drive manufacturers could be natural partners for EZTakes. At a minimum, it would seem to make sense for EZTakes to cross-promote with these organizations. It could also be possible to persuade these manufactures to pre-install the appropriate version of EZTakes on their drives that are themselves later installed in computers or other consumer devices. Alternatively, hard drive makers could be persuaded to include an EZTakes client installation CD/DVD (along with, perhaps, some promotional content) with drives that are purchased individually. These possibilities seem reasonable, given that EZTakes could add tremendous value to hard disk products. Incidentally, what is true for hard drive makers could also be true for makers of other storage media, such as memory cards, or even the manufacturers and distributors of blank re-writable DVD media.

Numerous other partnership opportunities exist. For example, EZTakes functionality can be added to Web sites that are branded by other companies. These Web sites could be the content producers, or DVD and movie merchandising companies. Companies that provide physical DVD on-line stores to rights holders could also use EZTakes to provide an electronic delivery option. EZTakes functionality could be added to the Web sties that already sell content downloads in order to enable their customers to burn content to DVDs. With the EZTakes rental option, the service could make a great electronic adjunct to on-line physical DVD rental services such as Netflix.

Inherent Advantages Over Alternative Models for Content Distribution

EZTakes competes with both traditional retail distribution channels for physical content, such as video stores like Blockbuster, as well as other electronic distribution services like MovieLinks and CinemaNow. EZTakes also competes with hybrid Internet/mail order services like Netflix, where content is specified on-line in a very similar way to EZTakes, but DVDs are delivered and returned via regular mail. The advantages of EZTakes are most apparent when one considers the EZTakes target market: households that own at least one DVD player, as well as PCs with a standard sized hard drive (80 or more gigabytes), DVD/CD burners and are connected to the Internet via an “always-on” broadband link, such as a cable modem or Digital Subscriber Line (DSL).

EZTakes' main advantages over physical distribution channels include cost, convenience and the richer user experience made possible by using an on-line automated system. The cost advantages are due to the fact that EZTakes eliminates all but a fraction of the inventory and handling overhead of physical distribution, while still enabling a customer to end up having a physical DVD. Because the incremental costs of distributing a particular piece of content over EZTakes is minimal, rental and sales costs can be lower than physical distribution, even if incremental profit margins for both EZTakes and content owners remains the same. As described in the “Joe” example in this document, many potential EZTakes customers will find that having a significant selection of high-quality content pre-delivered to the EZTakes Personal Content Store on their computer, with immediate access to reviews, previews and so on, to be a much more convenient experience and a more efficient use of time than having to make a trip to a video store and perhaps spend a lot of time wandering up and down the rows of video shelves.

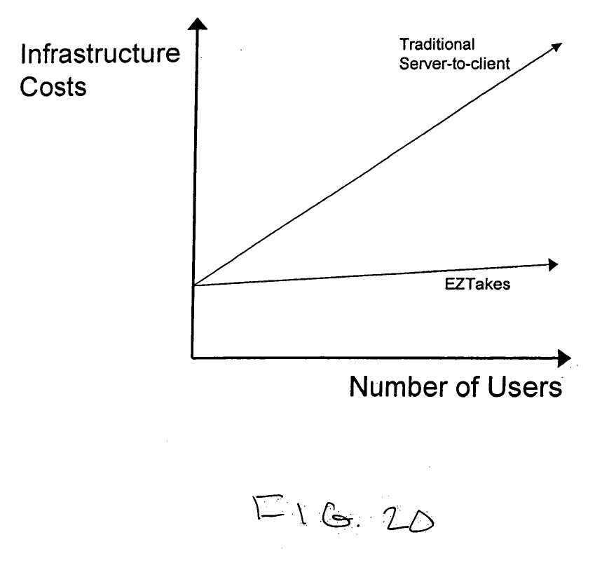

On-line services like Movielinks and CinemaNow have some significant disadvantages with respect to EZTakes. These services employ a fairly traditional server-to-client download configuration for delivering content, which is much more costly and much less scalable than EZTakes. As explained in the Joe example, the key to EZTakes' scalability is that as more clients that join the network, the more scalable the network becomes. Moreover, the more clients that request and download a particular piece of content, the better the availability of that content will be to other clients. Although EZTakes offers dramatically better scalability over a traditional server-to-client download model, EZTakes, when implemented in a fully peer-to-peer manner, does not need the same level of infrastructure investment (e.g. server hardware, software and network bandwidth). FIG. 20 illustrates the relationship between infrastructure costs and the number of users. As shown in FIG. 20, the infrastructure costs of a traditional client-to-server distribution model increase in direct relation to the number of users supported, while EZTakes' infrastructure costs stay nearly constant as the number of users increases. Consequently, EZTakes using peer-to-peer will always have an inherent advantage of lower distribution costs with respect to services like CinemaNow and MovieLinks, at least in their current form.

Another advantage of EZTakes over alternative on-line services is the EZTakes burn-and-return approach to content distribution. Alternative on-line services tend to take a highly restrictive position with respect to the use of content. Because of the DRM solutions implemented by these services, the customer's experience is much less satisfying. Content typically is played on the same computer used to download the content and rental timeframes are relatively short. For example, one service requires customers to pay for the rental immediately and begin playing a movie within 30 days of a download. Once the customer starts playing a movie, the customer has 24 hours to see it, after which is will be deleted. In addition, because these services employ an on-demand model for content download, it may take up to a few hours to fully acquire a movie after the user selects it for rental, even though these services invariably also reduce the quality of the content and use a special compression algorithm to reduce download time. The bottom line is that in contrast to EZTakes, these services fail to bridge the gap between the customer's PC in the home office and the entertainment experience of the living room because of technical incompatibilities and self-imposed restrictions.

Netflix provides another alternative content distribution channel. Under this model, customers pay a monthly subscription fee, which is currently less than $20. For this amount a customer can go on-line to the Netflix Web site and order content to be delivered via regular mail. Users can order up to three DVDs at a time this way. New DVDs are sent to the customers as soon as they return previously rented DVD via regular mail. The success of Netflix has been attributed to this aspect of its subscription model; for a flat monthly fee, the number of DVDs that Netflix customers can enjoy is only limited by how fast they can view them and how fast the physical media can be delivered.

Although the Netflix subscription model has proven to be successful, EZTakes offers several inherent advantages over it. First of all, the Netflix organization is still subjected to the costs and challenges of managing a physical inventory. To return to the Joe example, suppose Joe tried to order the Gladiator movie from Netflix. In order to be able to rent this content, Netflix would have had to purchase and stock a certain number of copies of this movie. Now suppose Netflix purchased 250 Gladiator DVDs, but then 1,000 other Netflix customers ordered it at the same time that Joe did. In this example, some Netflix customers could get the Gladiator movie within perhaps a few days, while the rest would have to wait in line for others to return their DVDs to Netflix to be reprocessed and mailed again. Some customers might have to wait as much as a few months. This likelihood of customer inconvenience as well as the inventory and handling costs associated with the Netflix model do not exist with the EZTakes model; one copy of content can be replicated rapidly over EZTakes' dramatically more scalable peer network at only a small fraction of the incremental costs, giving EZTakes both a cost and a customer service advantage over the Netflix model. Furthermore, rather than having to return the Gladiator DVD so that it could be rented and mailed again, EZTakes customers may well decide to purchase a permanent copy of Gladiator after renting, which would create no inventory management problem for EZTakes and actually expand the revenue opportunities for both the EZTakes service and the content owners.

Other Potential Advantages

The creators of EZTakes are working on additional inventions that may give EZTakes a proprietary advantage over competitors. One of these technologies is in the still immature area of digital rights management (DRM). Artio's position on current DRM technologies is that they are typically too restrictive and too cumbersome. Indeed, paranoia seems to be one of the underlying motivations for the creation of many DRM solutions. Devoting tremendous effort to create unwieldy DRM technologies does not make sense when one considers that anyone bent on pirating a piece of content can simply purchase it through a traditional retail outfit and post it on an illegal file sharing network. Since content purchased via traditional physical channels typically contains no unique watermark, it is very difficult to trace to an individual. Artio believes that devoting tremendous resources to DRM may be analogous to replacing your front door with a bank vault door in order to protect your home from intrusion while leaving your windows and back door unlocked. Consequently, any DRM solution utilized by EZTakes is as fast, reasonable and non-intrusive to the customer as the technology and legal considerations will permit.

One DRM technology that Artio is working on attempts to exploit the EZTakes Peer Network in order to create a robust DRM solution that is fast and presents enough of a barrier to would-be attackers so as to encourage them to take another route. By leveraging the peer network, the EZTakes service could instruct one or more of the peer servers that are providing any particular piece of content to other clients to employ any one of a number of protection algorithms to make the file unusable unless it is unlocked via the EZTakes rental or purchase process. If, for example, the EZTakes service instructed only two peer servers that are providing one part each out of 100 or so parts of a full-length DVD movie, a potential hacker would first have to determine which parts have been protected, what algorithms were used to protect those parts and then break those algorithms. In order to increase the level of protection, EZTakes could easily and dynamically increase the number of parts to protect and employ additional versions and variations of protection algorithms. These algorithms could include any number of known approaches, or utilize off-the-shelf and/or proprietary Artio techniques. Since the EZTakes server controls and tracks the entire process, it has the sole ability to give EZTakes clients the information needed to unlock rented and/or purchased content. Furthermore, since the protection algorithms deployed only impact a small part of what could be a multi-gigabyte movie file, unlocking the content would be much more efficient and faster than, for example, attempting to decrypt an entire movie file.

Artio also currently intends to develop a service that scans all major and known file sharing sites for illicit copies of content that contain EZTakes watermarks. This may be provided as a free service to protect the interests of content owners or be provided for a fee.

The DRM technology under design and development at Artio is just one example of some of the innovative approaches Artio is seeking to exploit by leveraging some of the relatively unique advantages of its approach to commercial rich content distribution over the Internet.

Privacy Concerns

The EZTakes service has a tremendous opportunity to gather valuable information about customers' viewing and purchasing habits. While having this information gives EZTakes the opportunity to better service its customers and potentially take advantage of additional revenue opportunities, it will be important to make responsible use of this information so as not to violate customer privacy. The developers of EZTakes will be quite mindful of this issue as the EZTakes service matures. Artio will carefully consider all reasonable technical, legal and procedural measures.

Content Licensing Issues

One of the most significant challenges for growing the EZTakes service is the need to convince the content owners, such as movie production companies, to authorize EZTakes to distribute content assets. As the EZTakes service proves itself to be a reliable and secure service that not only provides great value to its customers, but also protects the interests of content owners while expanding their revenue opportunities, the amount of content available through EZTakes should grow dramatically. Of course, measures will be built into EZTakes to ensure that it is not used for illegal purposes such as content piracy.

Security Issues

Artio will take all reasonable measures not only to prevent the illegal use of its software and network and to prevent the compromise of the physical and technical integrity of the EZTakes service. This will include enlisting the services of a professional hosted service provider and insuring that all necessary and reasonable measures are used to protect the system from intrusion. The security and reliability of the service, as well as the ethical standards exhibited by Artio, will be critical in gaining the trust of content owners and customers, which is necessary for EZTakes to succeed.

Internationalization

The market for EZTakes is not limited to the US. Indeed, many other countries have sizable numbers of potential customers that are likely to be able to derive great benefit from the EZTakes service. Consequently, EZTakes has been designed to be able to support, for example, multiple languages and currencies. Artio plans to begin entering international markets with localized EZTakes services as soon as it makes technical and business sense.

Copy Protection Issues

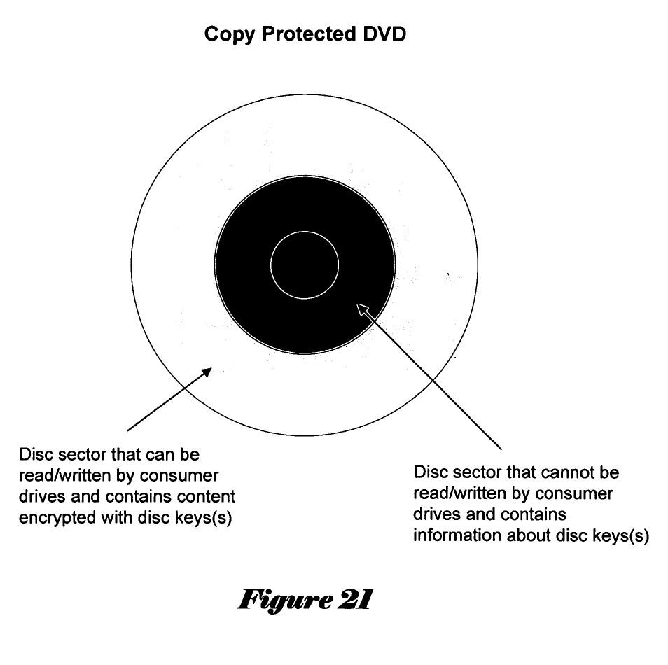

Most commercial DVDs employ a copy protection technology known as the Content Scrambling System, or CSS. A very simply description of CSS is that it utilizes a disc key to encrypt the content that is stored on the disc. The disc key cannot be accessed by normal computer applications. Consequently, if you copy a CSS-protected DVD to another media (e.g. writable DVD or a hard drive), the copy will not be playable since you will not be able to copy the disc key. All CSS-enabled DVD players—which include practically all—must use the disc key to decrypt and play CSS-protected DVDs. FIG. 21 shows the basic structure of a copy-protected disc.

The problem with CSS is that it has been broken. In fact, software that enables users to create perfect and unprotected copies of any CSS-protected discs, is freely available on the Internet. Consequently, anyone that can download and install software can also defeat CSS. So while CSS provides some protection from casual content pirates, it does not protect rights holders from the large-scale content copiers and bootleggers that are much more likely to inflict significant monetary damage. Nonetheless, most rights holders are emotionally attached to CSS. To be fair, however, it is important to note that CSS does provide some added protection to rights holders since the Digital Millennium Copyright Act of 1998 makes circumventing technical protection measures such as CSS, a violation of the law in itself.

As you may have already noted, a problem with delivering burnable content as electronic downloads is that the burners owned by consumers cannot burn CSS-protected discs. As previously mentioned, consumer burners cannot even directly access, never mind write to, the section of a disc where CSS key information must be located. The end result is that many content owners are unwilling to license their content to be sold as burnable downloads because CSS cannot be applied to the content. Artio is addressing this issue with what it calls Pseudo CSS.

Pseudo CSS involves creating recordable DVD media that has been altered to include encryption key information that is pre-recorded or pre-stamped in the appropriate disc sector. The content sector, however, will be blank and may be written to by consumer DVD burners. Either the EZTakes will pre-encrypt the content with key information that is compatible with the key information that was preset on the altered recordable disc. Consequently, the content on the altered disc will not play if it is copied to another disc; however, playback devices will recognize the altered recordable disc as a valid CSS-protected disc. While Pseudo CSS copy protection is even easier to defeat than CSS (in Pseudo CSS, once the key is known it can be used to decrypt anything EZTakes copies to the disc), the important point is that a program is required in order to circumvent either CSS or Pseudo CSS. Therefore, it takes just as much effort and expertise to circumvent Pseudo CSS as it does to break CSS.

Since having a Pseudo CSS feature could be critical to convincing rights holders to license their content for download, it may be the “killer feature” for the download-burn-and-return rental model described in this document. Current on-line rental services, such as Netflix, Wal-Mart, Blockbuster and Amazon (currently announced in the United Kingdom), could easily distribute the altered DVDs to their customers and subscribers (under license from Artio of course).

Distributing Video Content Over Third Party Peer to Peer Networks

It is possible to distribute EZTakes content over third party peer-to-peer networks that Artio does not control (e.g. eDonky, numerous Bittorrent networks, etc.). In this situation, customers may be allowed to view, for example, the first ten minutes of a content title; however, they must make a payment for content if they wish to burn it or watch it in full. The customer would also need the EZTakes Download Manager (or compatible software). The user can be instructed to install the EZTakes Download Manager.

Glossary of Terms

Burning—The process of storing content on a DVD or CD.

Burn and Return—A process employed by EZTakes by which customers can burn rented content onto re-writable DVDs and/or CDs, and then return the content by using the EZTakes software to verify the content is indeed the content that was originally rented and then overwrite the content, which removes the content from the CD/DVD media.

CD—A standard media storage disk that can be read by using a laser-based CD reader/player. CDs typically have a capacity of 650 megabytes. While a typical DVD formatted file is too large to be practical for CDs and CD players cannot play DVD files, it is possible to burn VCD formatted files onto CDs by using a stander CD burner, and then play this content on most standard CD and DVD players.

Content—Includes most information that is typically distributed to consumers via DVD and/or CD media, or downloaded over the Internet. This can include movies, other videos (e.g. TV specials), games, music and other information in digital form.

Disc—When spelled this way, this term typically refers to removable optical media, such as a DVD or Video CD.

Download—The process of copying a file from another device on a network. Traditionally this is done via a one-to-one connection between devices. In the case of EZTakes, a download can also involve one device copying parts of a file from many nodes on a network and then assembling these parts into usable content.

DVD—A standard media disk that can be read by using a laser-based DVD reader/player. DVDs typically have a capacity of 4.7 gigabytes, which is large enough to store most movies at a very high quality.

DRM (Digital Rights Management)—Technical approaches to control the use of digital assets, such as movie files downloaded over the Internet. Many content owners hope to rely on DRM solutions to ensure that they will be paid for the use of their content. DRM technologies typically employ cryptographic techniques and other mathematical algorithms to protect content from unauthorized use.

EZTakes Client—The software portion of the EZTakes service that runs on a computer or other device owned by an EZTakes customer.

EZTakes Peer Network—The collection of all EZTakes customers' computers that serve as network nodes and can be leveraged by the EZTakes service to distribute content to other clients.

EZTakes Peer Server—An EZTakes client that also serves content to other EZTakes clients. Some or all EZTakes clients can be peer servers. A “seed” peer server is one of the initial peer servers that the EZTakes service first propagates content to in order to begin to distribute it to any requesting customer.

EZTakes Server—The software and hardware portion of the EZTakes service that runs as a hosted service on the Internet and serves multiple EZTakes clients. There can be multiple instances of EZTakes servers installed in one of more locations.

On-line Return Affidavit—A feature of the EZTakes service that can be offered on a limited basis to some EZTakes customers. This service essentially enables customers to certify on-line that content rented via EZTakes has either been lost, destroyed or otherwise cannot be verifiably returned via the service's burn and return feature.

Personal Digital Watermark (PDW)—An alteration to a content file delivered to a customer by the EZTakes service. This alteration makes the file unique and traceable to the customer that rented or purchased it. Multiple PDWs can be employed by EZTakes to help ensure that content downloaded via the service can be traced back to customers that may have used it inappropriately. For example, a PDW could be a splash screen shown at the beginning of a movie. This splash screen might list the customer name or EZTakes user ID of the renter, as well as provide information regarding the appropriate use of the content. The same content file could also include additional PDWs that could be detected and verified by a computer program. EZTakes can utilize PDWs to verify when a particular piece of content is returned (i.e. destroyed) via the service's burn and return feature.

Pseudo CSS—A process invented by Artio Systems by which otherwise standard writable DVDs are pre-imprinted with decryption key. Consumers can later burn properly encrypted content to the altered disc. The resultant disc appears to standard DVD playback devices as a standard CSS-protected DVD. Direct copies of the Pseudo CSS-protected DVD are typically not playable.

MPEG 2—The file format used for most video content burned to DVD media.

VCD—Video format that is compatible with most CD burners, as well as CD readers and DVD players. VCD is similar in quality to VHS tapes.

Although the present invention has been described in terms of particular embodimenst, it is not intended that the invention be limited to these embodiments. Modifications within the spirit of the invention will be apparent to those skilled in the art. For example, the software for EZTakes may be implemented in numerous different programming languages for execution on many different operating systems running on different types of computers, using many different modular organizations, control structures, variables, and other such implementation choices.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for distributing information over an electronics communication medium, the method comprising:
providing a client-side executable to a client computer;
downloading portions of selected content to the client computer from various peer computers to the client computer;
allowing for copying of the content to a CD; and
allowing the content to be returned by erasing or overwriting the CD.
